(19) United States
(12) Patent Application Publication
(10) Pub. No.: US 2013/0091468 A1
(43) Pub. Date: Apr. 11, 2013

(54) INDIVIDUALIZED METHOD FOR UNLOCKING DISPLAY SCREEN ON MOBILE COMPUTING DEVICE AND SYSTEM THEREOF

(71) Applicant: Jian Xie, Jiangxi (CN)

(72) Inventor: Jian Xie, Jiangxi (CN)

(21) Appl. No.: 13/646,742

(22) Filed: Oct. 8, 2012

(30) Foreign Application Priority Data
Oct. 8, 2011 (CN) 201110294943.6

(51) Int. Cl. G06F 3/048

(52) U.S. Cl. 715/835

(57) ABSTRACT

An individualized method and a system for individually unlocking a display screen on a mobile computing device are disclosed. The method includes displaying an icon serving as an unlocking hot key on the display unit; selecting the unlocking hot key, by using an input unit connected to the display unit, to produce a first activating signal; displaying icons serving as application hot keys on the display unit according to the first activating signal; sliding on the input unit and selecting the unlocking hot key and one of the application hot keys, to produce a second activating signal; and unlocking the display screen and then performing an application corresponding to the selected application hot key, according to the second activating signal. With such an unlocking mechanism, the invention makes performing unlocking a mobile computing device more flexible and efficient.

### CROSS-REFERENCE TO RELATED APPLICATION

This application claims the priority benefit of China application serial no. 201110294943.6, filed on Oct. 8, 2011. The entirety of the above-mentioned patent application is hereby incorporated by reference herein and made a part of this specification.

### BACKGROUND

1. Field of the Invention

The invention relates to an individualized method for unlocking display screen, in particular, to an individualized method for unlocking display screen performed by touching and sliding on hot keys.

2. Description of Related Art

In the current era of information explosion, electronic communication is indispensable in people's daily life, and people often use portable electronic devices to communicate with each other, especially mobile communication devices that can be carried around, for example, mobile phones or mobile devices having a wireless communication function, etc. However, regarding the portable mobile device requiring features of lightness, slimness, shortness and smallness, a size thereof is strictly limited, so that a touch screen technique is developed to integrate a soft keyboard with a screen to serve as an input interface of the portable electronic device, so as to save cost of a conventional keyboard and an area occupied by the conventional keyboard.

However, the touch screen is quite sensitive to an external touch action, and a user may inadvertently touch a screen key displayed on the touch screen to execute a specific function, for example, a call function by accident.

### SUMMARY

In view of problems in the prior art, an object of the invention is to provide an individualized method for unlocking display screen on a mobile computing device, such that unlocking of the mobile computing device can be performed more flexibly and efficiently.

According to an object of the invention, the invention provides an individualized method for unlocking a display screen on a mobile computing device, wherein the display screen is on a display unit of the mobile computing device. The method includes the following steps: displaying an icon on the display unit, the icon serving as an unlocking hot key for unlocking the display screen; selecting the unlocking hot key, by using an input unit connected to the display unit, to produce a first activating signal; displaying a plurality of icons on the display unit according to the first activating signal, the icons serving as application hot keys for activating applications; sliding on the input unit and selecting the unlocking hot key and one of the application hot keys, to produce a second activating signal; unlocking the display screen and then performing an application corresponding to the selected application hot key, according to the second activating signal. It's noted that the two steps of sliding on the input unit and selecting the unlocking hot key and one of the application hot keys need not be performed simultaneously.

According to an embodiment of the invention, the step of displaying the plurality of icons on the display unit according to the first activating signal includes displaying the application hot keys around the unlocking hot key.

According to an embodiment of the invention, the step of sliding on the input unit and selecting the unlocking hot key and one of the application hot keys to produce a second activating signal includes sliding from the unlocking hot key to the selected application hot key to produce the second activating signal.

According to an embodiment of the invention, the step of sliding on the input unit and selecting the unlocking hot key and one of the application hot keys includes selecting the unlocking hot key and then sliding from the selected application hot key, through the application hot keys around the selected unlocking hot key, to the selected application hot key again, to produce the second activating signal.

According to an embodiment of the invention, the input unit includes a touch panel.

According to an object of the invention, the invention provides an individualized method for unlocking a mobile computing device, having a display unit. The method includes the following steps: displaying an icon on the display unit, the icon serving as an unlocking hot key for unlocking the mobile computing device; selecting the unlocking hot key, by using an input unit connected to the display unit, to produce a first activating signal; displaying a plurality of icons on the display unit according to the first activating signal, the icons serving as application hot keys for activating applications; sliding on the input unit and selecting the unlocking hot key and one of the application hot keys, to produce a second activating signal; unlocking the mobile computing device according to the second activating signal. It's noted that the two steps of sliding on the input unit and selecting the unlocking hot key and one of the application hot keys need not be performed simultaneously.

According to an object of the invention, the invention provides a system for individually unlocking a mobile computing device. The system includes a storage unit, a display unit, an input unit and a processing unit. The storage unit stores data of an application. The display unit is configured to display an icon serving as an unlocking hot key for unlocking the mobile computing device and to display an icon serving as an application hot key for activating the application. By the input unit, the unlocking hot key can be selected to produce a first activating signal, and the application hot key can be selected to produce a second activating signal. The processing unit is configured to direct the display unit to display the application hot key according to the first activating signal, and configured to perform the application according to the second activating signal.

According to an embodiment of the invention, a plurality of the application hot keys are displayed according to the first activating signal.

According to an embodiment of the invention, the plurality of the application hot keys are displayed around the unlocking hot key.

According to an embodiment of the invention, the input unit includes a touch panel.

According to an embodiment of the invention, the system includes or composes the mobile computing device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a system for individually unlocking a mobile computing device according to an exemplary embodiment of the present invention.

FIG. 2 is a flow chart of an individualized method for unlocking a display screen on a mobile computing device according to an exemplary embodiment of the present invention.

FIGS. 3A-3C are schematic diagrams illustrating sequential steps of performing the individualized method for unlocking a display screen on a mobile computing device according to the embodiment illustrated in FIG. 2.

FIGS. 4A-4C are schematic diagrams illustrating sequential steps of performing the individualized method for unlocking a display screen on a mobile computing device according to another exemplary embodiment of the present invention.

FIG. 5 is a flow chart of an individualized method for simply unlocking a display screen without accessing any application according to an exemplary embodiment of the present invention.

FIGS. 6A-6B are schematic diagrams illustrating sequential steps of performing the individualized method for simply unlocking a display screen on a mobile computing device according to the embodiment illustrated in FIG. 5.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

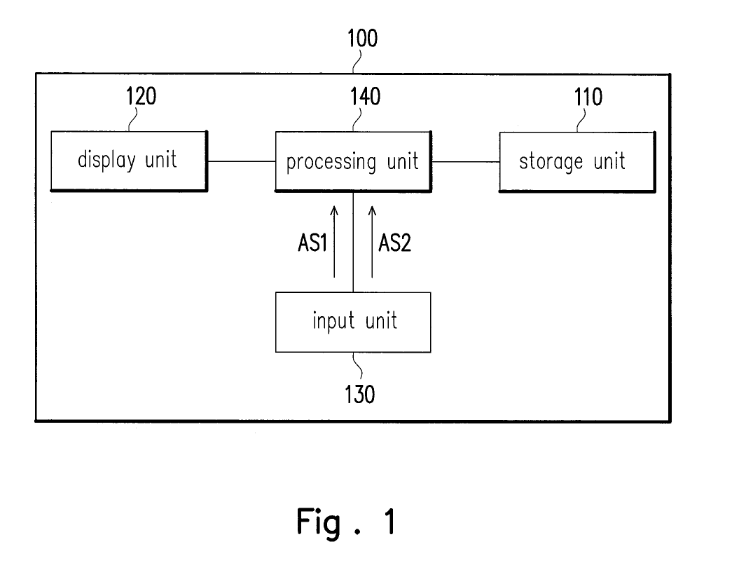

FIG. 1 is a functional block diagram of a system 100 for individually unlocking a mobile computing device according to an exemplary embodiment of the present invention. In this embodiment, the system 100 may be disposed in the mobile computing device to perform the steps for unlocking the locked display screen of the mobile computing device. The system 100 includes a storage unit 110, a display unit 120, an input unit 130 and a processing unit 140. The storage unit 110 is configured for storing data of an application. The display unit 120 is configured to display an icon, which serves as an unlocking hot key for unlocking the mobile computing device and to display an icon serving as an application hot key for activating the application. By the input unit 130, the unlocking hot key can be selected to produce a first activating signal AS1, and the application hot key can be selected to produce a second activating signal AS2. The processing unit 140 is configured to direct the display unit 120 to display the application hot key according to the first activating signal AS1, and configured to perform the application according to the second activating signal AS2. In some embodiment, the mobile computing device may be, but not limited to, a feature mobile phone, a smart phone, a PDA or a tablet. In addition, the mobile computing device may be composed of the system 100. It should be noted that in this and the following illustrated embodiments, a mobile phone is taken to be representative of the mobile computing device to which the individualized method and system of the present invention are directed.

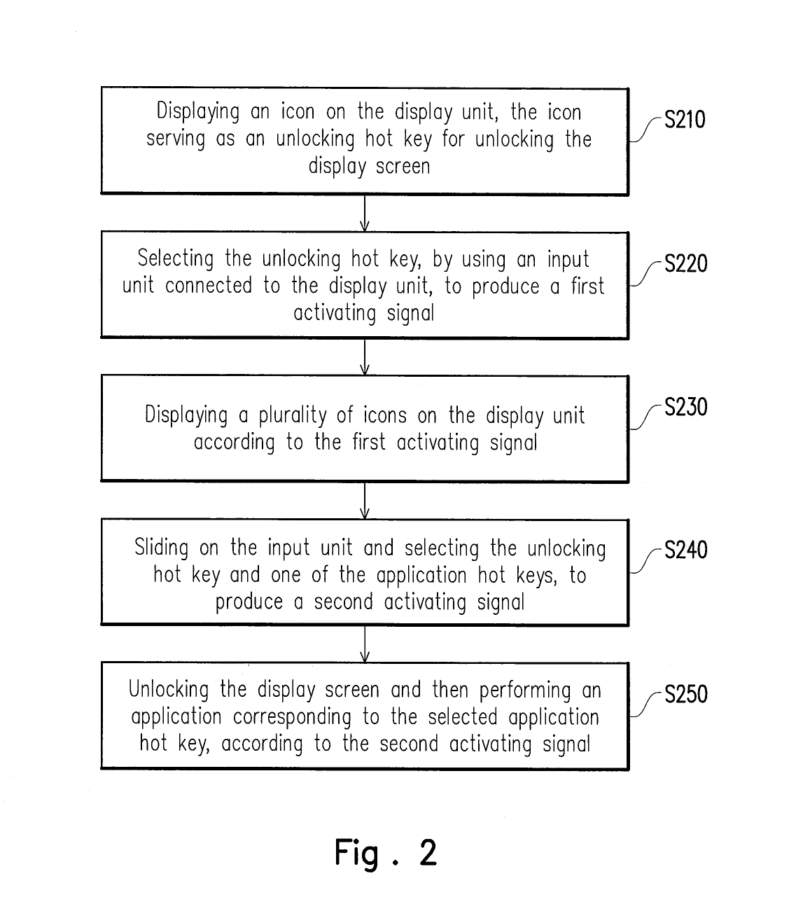

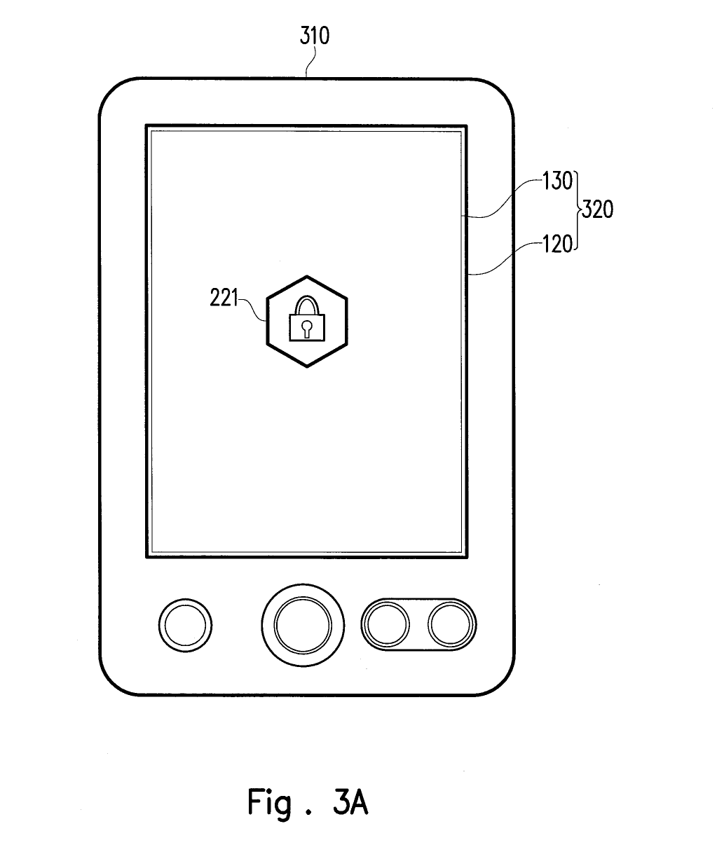

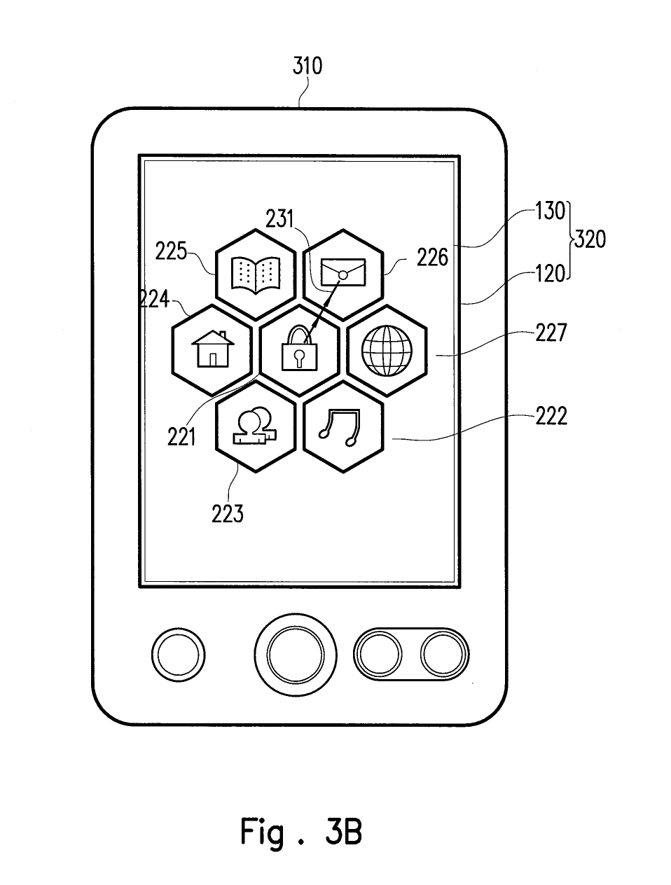

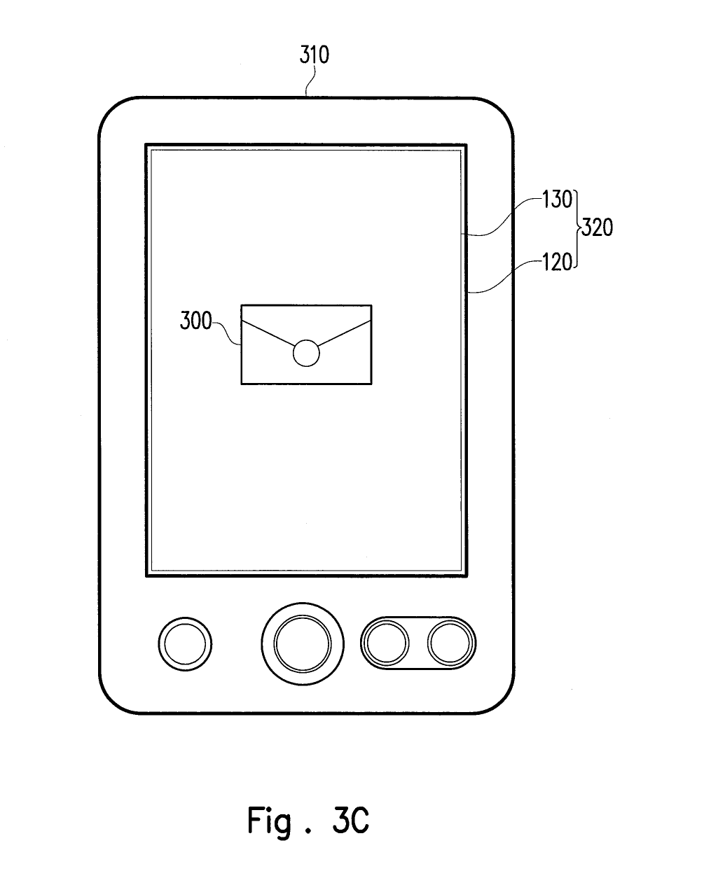

FIG. 2 is a flow chart of an individualized method for unlocking a display screen on a mobile computing device according to an exemplary embodiment of the present invention. FIGS. 3A-3C are schematic diagrams illustrating sequential steps of performing the individualized method for unlocking a display screen on a mobile computing device according to the embodiment illustrated in FIG. 2. Referring to FIGS. 1, 2 and 3A-3C, the method for unlocking the display screen on a mobile computing device may be adapted for the foregoing system 100, which may be disposed in a mobile computing device 310, but the invention is not limited thereto. In the embodiment illustrated in FIGS. 3A-3D, the display unit 120 and the input unit 130 may be integrated to construct a touch screen display 320, where the input unit 130 may be a touch panel connected to the display unit 120 and having sensing areas corresponding to the display area of the display unit 120.

As illustrated in FIG. 3A, when a display screen on the display unit 120 of the mobile computing device 310 is locked to prevent accidentally touching, the display unit 120 may display an icon 221, which may serve as an unlocking hot key for unlocking the display screen of the display unit 120 (step S210). At this time, the user may select the unlocking hot key (i.e., the icon 221) by touching (or pressing) the touch screen display 320 with a finger or a stylus, and the input unit 120 of the touch screen display 320 would produce (or generate) the first activating signal AS1 in response to the user's touching action (step S220). As illustrated in FIG. 3B, during the unlocking hot key (i.e., the icon 221) being selected (i.e., touched or pressed), the processing unit 140 may direct (or control) the display unit 120 to display other icons 222-227 according to the first activating signal AS1 (step S230), where the icons 222-227 are surrounding the unlocking hot key (i.e., the icon 221). However, the illustrations about the locations of the icons 222-227 in FIG. 3B are simply possible allocations of the present invention, and the deployments of the icons 222-227 are not limited thereto.

Each of the icons 222-227 may serve as an application hot key for a specific application, which may be stored in the storage unit 110. For example, the icon 222 represented by a musical note may be configured to be a shortcut which can access an application of a music player; the icon 223 illustrated as two overlapping people may be a shortcut which can access a contact list of the user, etc. The applications related to the icons 222-227 may be adjusted according to various demands of the designer of the system 100, which is not limited thereto.

While the display unit 120 is displaying the icons 222-227, the user may further slide the touching finger (or stylus) on the input unit 130 to one of the icons to select the desired application. For example, when the user slides the touching finger (or stylus) to the icon 226 along a direction 231 (which may be a shortcut to access an e-mail application) after selecting the unlocking hot key (i.e., the icon 221), the input unit 130 would correspondingly produce (or generate) the second activating signal AS2 (step S240). Next, referring to FIG. 3C, the processing unit 140 may unlock the display screen of the display unit 120 and perform the e-mail application 300 corresponding to the selected application hot key (i.e., the icon 226) according to the second activating signal AS2 transmitted by the input unit 130.

In other embodiments, when the touching finger (or stylus) of the user stays at one of the application hot key, the input unit 130 may start accumulating the time that the touching finger (or stylus) stays on the application hot key. After the accumulated time is over a predetermined time (e.g., 100 ms), the input unit 130 would produce (or generate) the second activating signal AS2, such that the processing unit 140 may unlock the display unit 130 and access the desired application. That is, when the accumulated time is not over the predetermined time, the input unit 130 would not produce the second activating signal AS2. Accordingly, after selecting the unlocking hot key, the user may slide the touching finger (or stylus) over a plurality of application hot keys without accessing any application corresponding to the slid application hot keys as long as each of the accumulated time of the application hot key is not over the predetermined time.

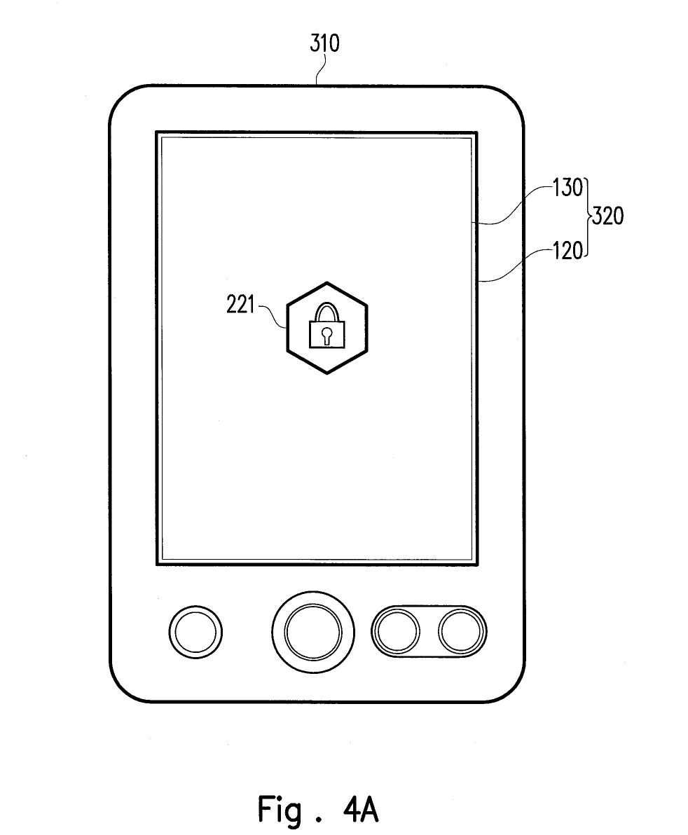

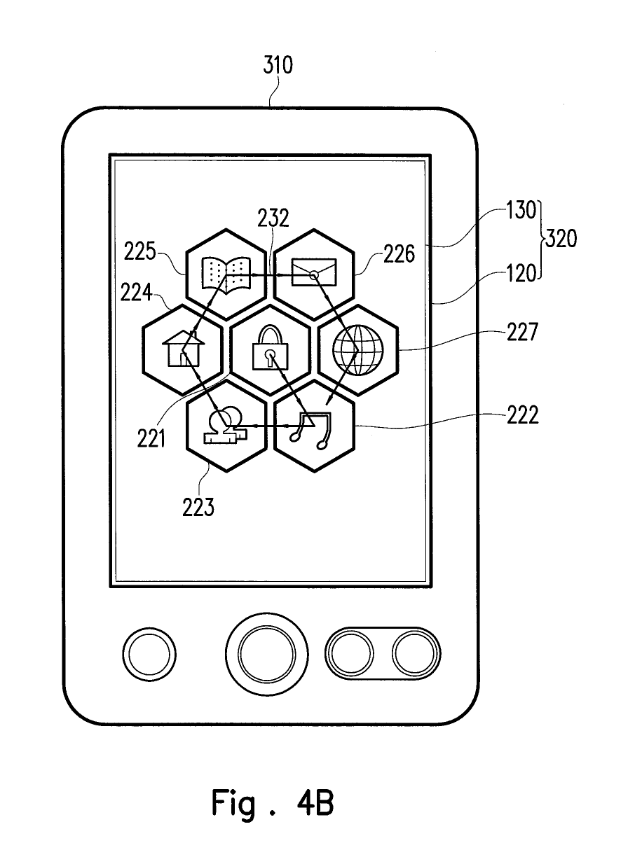

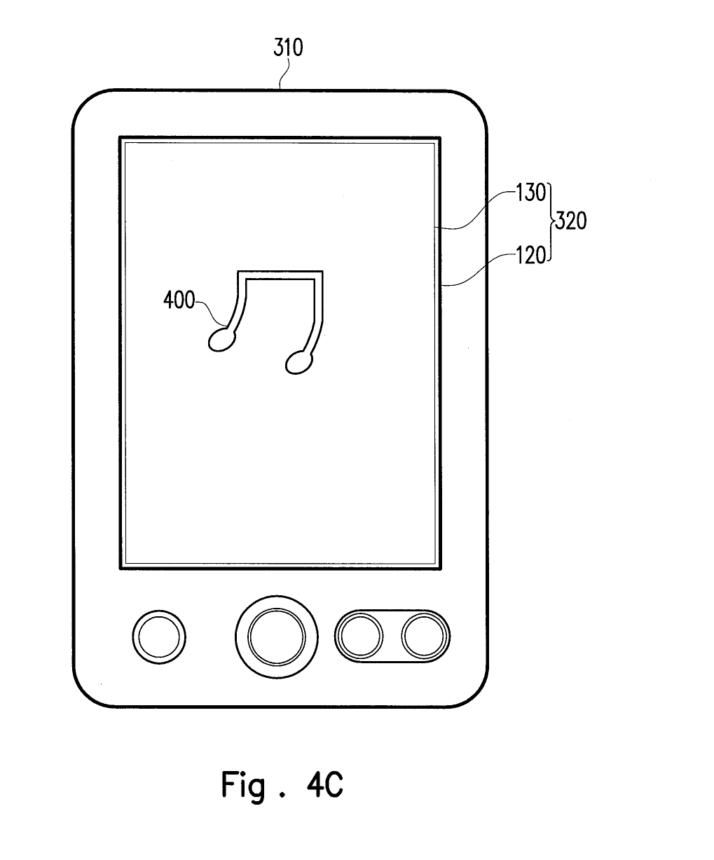

FIGS. 4A-4C are schematic diagrams illustrating sequential steps of performing the individualized method for unlocking a display screen on a mobile computing device according to another exemplary embodiment of the present invention. Referring to FIG. 4A, in this embodiment, when the display screen of the display unit 120 is locked to prevent accidentally touching, the display unit 120 may display the unlocking hot key (i.e., the icon 221) to facilitate the user to unlock the display screen. Referring to FIG. 4B, after the user selects the unlocking hot key (i.e., the icon 221), the processing unit 140 may direct (or control) the display unit 120 to display the application hot keys (i.e., the icons 222-227) in response to the first activating signal AS1 produced by the input unit 130.

Next, the user may sequentially slide over the icons 222-227 and back to the icon 222 along a direction 232 to access the corresponding application represented by the icon 222 as long as each of the accumulated staying time of the icons 223-227 is not over the predetermined time (e.g., 100 ms). Referring to FIG. 4C, the processing unit 140 may unlock the display screen of the display unit 120 and perform, for example, the music player application 400 corresponding to the selected application hot key (i.e., the icon 222) according to the second activating signal AS2 transmitted by the input unit 130.

Besides, in some embodiments, the system 100 may be designed with a predetermined unlocking order for the icons, such that when the user wants to access some applications other than the applications corresponding to the icons 222-227, the user may follow the predetermined unlocking order to touch the icons 222-227 to simply unlock the display screen without accessing any applications represented by the icons 222-227.

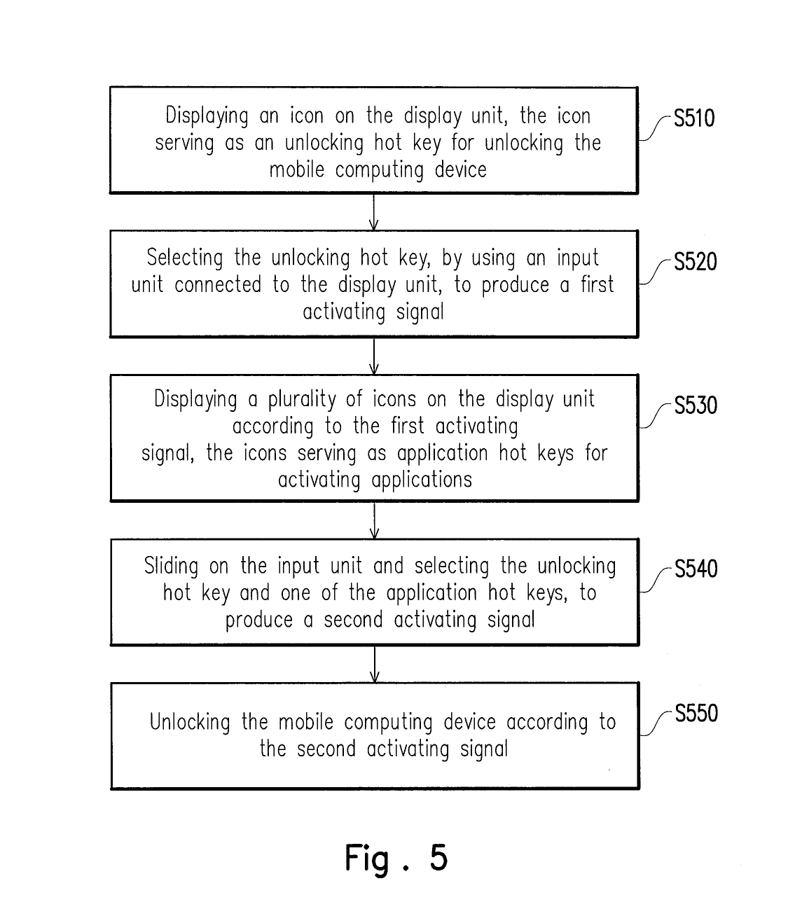

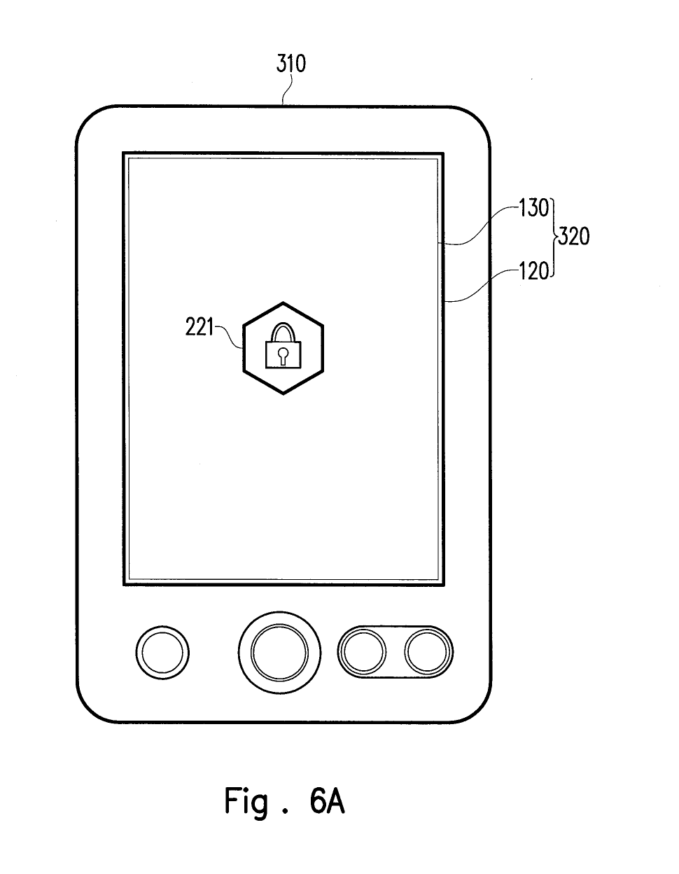

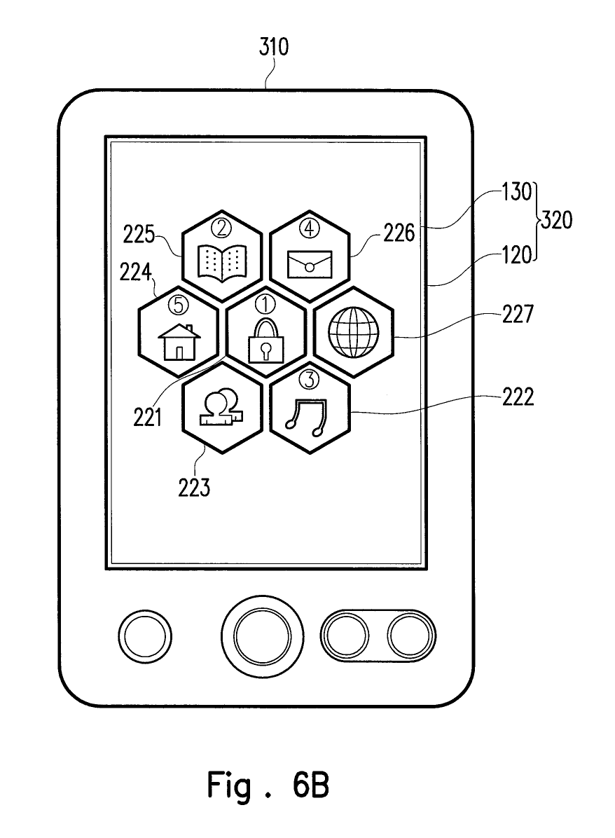

FIG. 5 is a flow chart of an individualized method for simply unlocking a display screen without accessing any application according to an exemplary embodiment of the present invention. FIGS. 6A-6B are schematic diagrams illustrating sequential steps of performing the individualized method for simply unlocking a display screen on a mobile computing device according to the embodiment illustrated in FIG. 5. Referring to FIGS. 1, 5 and 6A-6B, the method for unlocking the display screen on a mobile computing device may be adapted for the foregoing system 100, which may be disposed in a mobile computing device 310, but the invention is not limited thereto.

As illustrated in FIG. 6A, when a display screen on the display unit 120 of the mobile computing device 310 is locked to prevent accidentally touching, the display unit 120 may display an icon 221, which may serve as an unlocking hot key for unlocking the display screen of the display unit 120 (step S510). At this time, the user may select the unlocking hot key (i.e., the icon 221) by touching (or pressing) the touch screen display 320 with a finger or a stylus, and the input unit 120 of the touch screen display 320 would produce the first activating signal AS1 in response to the user's touching action (step S520). As illustrated in FIG. 3B, during the unlocking hot key (i.e., the icon 221) being selected (i.e., touched or pressed), the processing unit 140 may direct (or control) the display unit 120 to display other icons 222-227 according to the first activating signal AS1 (step S530), where the icons 222-227 are surrounding the unlocking hot key (i.e., the icon 221). However, the illustrations about the locations of the icons 222-227 in FIG. 6B are simply possible allocations of the present invention, and the deployments of the icons 222-227 are not limited thereto.

In this embodiment, the predetermined unlocking order of the icons 221-227 may be the icons 221, 225, 222, 226 and 224 as illustrated in FIG. 6B. Accordingly, when the user sequentially slides over the icons 221, 225, 222, 226 and 224, the input unit 130 may correspondingly produce the second activating signal AS2 and transmit the second activating signal AS2 to the processing unit 140. Next, the processing unit 140 may direct or control the display unit 120 to simply unlock the display screen instead of accessing the application represented by the last touched application hot key (i.e., the icon 224).

Therefore, when the application hot keys (i.e., the icons 222-227) are not the desired applications to the user, the user may follow the predetermined unlocking order to touch the icons 222-227 to simply unlock the display screen and find the desired application. Furthermore, the predetermined unlocking order may be modified according to the demands of the user or the designer, which is not limited thereto.

In summary, the present invention provides an individualized method for unlocking a display screen on a mobile computing device, which method makes performing unlocking the display screen of a mobile computing device more flexible and efficient. By sliding from the unlocking hot key to the desired application hot key, the user may directly access the desired application right after the display screen being unlocked, and therefore the user does not need to waste additional time to find the desired application after the display screen being unlocked.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An individualized method for unlocking a display screen on a mobile computing device, the display screen being on a display unit of the mobile computing device, the method comprising:
displaying an icon on the display unit, the icon serving as an unlocking hot key for unlocking the display screen;
selecting the unlocking hot key, by using an input unit connected to the display unit, to produce a first activating signal;
displaying a plurality of icons on the display unit according to the first activating signal, the icons serving as application hot keys for activating applications;
sliding on the input unit and selecting the unlocking hot key and one of the application hot keys, to produce a second activating signal; and
unlocking the display screen and then performing an application corresponding to the selected application hot key, according to the second activating signal.

2. The method according to claim 1, wherein the step of displaying the plurality of icons on the display unit according to the first activating signal comprises:
displaying the application hot keys around the unlocking hot key.

3. The method according to claim 1, wherein the step of sliding on the input unit and selecting the unlocking hot key and one of the application hot keys to produce a second activating signal comprises:
sliding from the unlocking hot key to the selected application hot key to produce the second activating signal.

4. The method according to claim 1, wherein the step of sliding on the input unit and selecting the unlocking hot key and one of the application hot keys comprises:
selecting the unlocking hot key and then sliding from the selected application hot key, through the application hot keys around the selected unlocking hot key, to the selected application hot key again, to produce the second activating signal.

5. The method according to claim 1, wherein the input unit comprises a touch panel.

6. An individualized method for unlocking a mobile computing device, having a display unit, the method comprising:
displaying an icon on the display unit, the icon serving as an unlocking hot key for unlocking the mobile computing device;
selecting the unlocking hot key, by using an input unit connected to the display unit, to produce a first activating signal;
displaying a plurality of icons on the display unit according to the first activating signal, the icons serving as application hot keys for activating applications;
sliding on the input unit and selecting the unlocking hot key and one of the application hot keys, to produce a second activating signal; and
unlocking the mobile computing device according to the second activating signal.

7. A system for individually unlocking a mobile computing device, comprising:
a storage unit for storing data of an application;
a display unit configured to display an icon serving as an unlocking hot key for unlocking the mobile computing device and to display an icon serving as an application hot key for activating the application;
an input unit by which to select the unlocking hot key to produce a first activating signal, and by which to select the application hot key to produce a second activating signal; and
a processing unit configured to direct the display unit to display the application hot key according to the first activating signal, and configured to perform the application according to the second activating signal.

8. The system according to claim 7, wherein a plurality of the application hot keys are displayed according to the first activating signal.

9. The system according to claim 8, wherein the plurality of the application hot keys are displayed around the unlocking hot key.

10. The system according to claim 7, wherein the input unit comprises a touch panel.

11. The system according to claim 7 comprising or composing the mobile computing device.
